(19) United States
(12) Patent Application Publication
(10) Pub. No.: US 2019/0017660 A1
(43) Pub. Date: Jan. 17, 2019

(54) INTERMEDIATE DRIVER MOUNT

(71) Applicant: KANGHONG ZHANG, SANTA FE SPRINGS, CA (US)

(72) Inventor: KANGHONG ZHANG, SANTA FE SPRINGS, CA (US)

(21) Appl. No.: 16/036,069

(22) Filed: Jul. 16, 2018

Related U.S. Application Data
(60) Provisional application No. 62/533,247, filed on Jul. 17, 2017.

(51) Int. Cl. F21K 9/278; F21V 23/06; H05B 33/08

(52) U.S. Cl. CPC F21K 9/278; H05B 33/0821; F21V 23/06

(57) ABSTRACT

An intermediate driver mount includes a driver having a first end and a second end, wherein the first end is opposite the second end. A first modular interface is formed on the first end, and a second modular interface is formed on the second end. Is A first lamp connected to the first modular interface, and a second lamp is connected to the second modular interface. The first lamp and the second lamp are both tube lamps. A first electrical connector is formed on the first lamp, and a second electrical connector is formed on the second lamp. The first lamp is configured to connect to a first socket, and the second lamp is configured to connect to a second socket. The driver is housed within a tube wall. The intermediate driver is an LED driver.

This application is a non-provisional application of and claims priority from U.S. provisional application 62/533,247 also entitled Intermediate Driver Mount, by same inventor Kanghong Zhang, filed Jul. 17, 2017, the disclosure of which is incorporated herein by reference.

### FIELD OF THE INVENTION

The present invention is in the field of lighting.

### DISCUSSION OF RELATED ART

Tube lighting was popularized when fluorescent lighting was at its zenith. Historically, drivers and ballasts were mounted to the lighting fixture for powering tube lighting.

Inventor Qifeng Ye describes a lighting system in US Patent publication number US2016/0255699 A1 entitled the Led Tube Lamp With Improved Compatibility With An Electrical Ballast that was published on Sep. 1, 2016. The abstract describes, “An LED tube lamp includes a lamp tube, a first external connection terminal and a second external connection terminal coupled to the lamp tube and for receiving an external driving signal; an LED lighting module coupled to the first external connection terminal and configured to receive a signal for emitting light, the signal derived from the first external driving signal; and a ballast interface circuit coupled between the first external connection terminal and the LED lighting module. The ballast interface circuit may be configured such that when the external driving signal is initially input at the first external connection terminal and second external connection terminal, the ballast interface circuit will initially be in an open-circuit state, which prevents the LED tube lamp from emitting light, until the ballast interface circuit enters a conduction state, which conduction state allows a current input at the first external connection terminal/second external connection terminal to flow through the LED lighting module and thereby allows the LED tube lamp to emit light.”

Inventor Aiming Xiong describes a lighting system in US Patent publication number US20170094746A1 entitled the Led Tube Lamp With Two Operating Modes Compatible With Electrical Ballasts that was published on Mar. 30, 2017. The abstract describes, “An LED tube lamp is disclosed. The LED tube lamp includes an LED module for emitting light, the LED module comprising an LED unit comprising an LED; a rectifying circuit for rectifying an external driving signal to produce a rectified signal; and a mode determination circuit configured to detect a state of a property of the rectified signal, for selectively determining on performing a first mode or a second mode of lighting according to the state of the property of the rectified signal; wherein when the LED tube lamp performs the first mode of lighting, the mode determination circuit allows continual current to flow through the LED unit until the external driving signal is disconnected from the LED tube lamp; and when the LED tube lamp performs the second mode of lighting, the mode determination circuit regulates the continuity of current to flow through the LED unit.”

### BRIEF DESCRIPTION OF THE DRAWINGS

FIG. 1 is a diagram of a linear configuration the present invention in a first mode.

FIG. 2 is a diagram of a bend configuration of the present invention in a second mode.

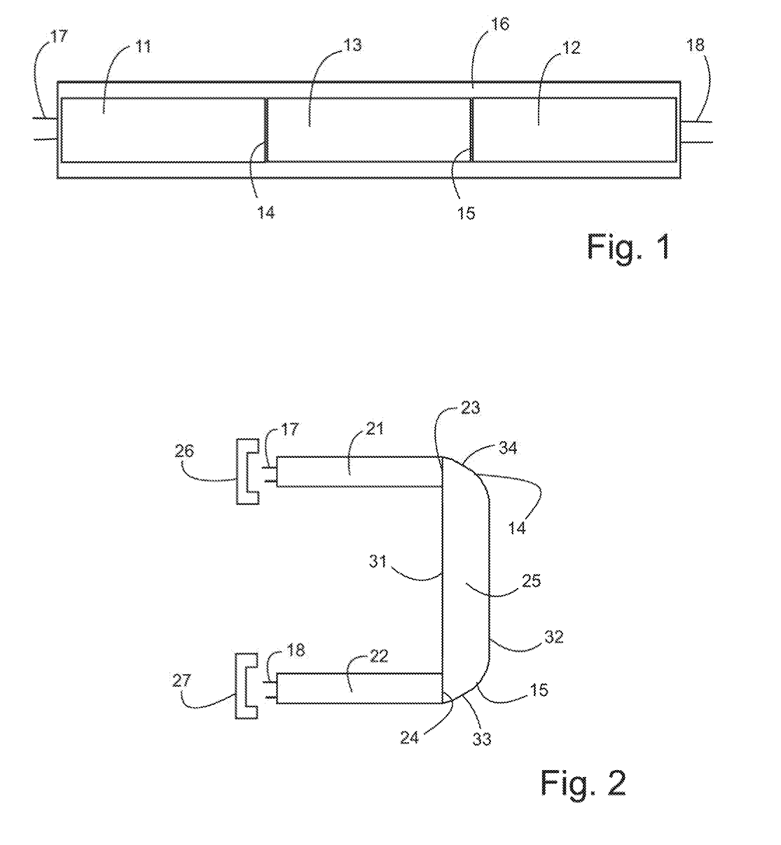

The following call out list of elements can be a useful guide in referencing the call numbers of the drawings.
11 Straight First Lamp
12 Straight Second Lamp
13 Straight Led Driver
14 First Modular Interface
15 Second Modular Interface
16 Tube Wall
17 First Electrical Connector
18 Second Electrical Connector
21 First Lamp
22 Second Lamp
23 Bent First Modular Interface
24 Bent Second Modular Interface
25 Bent Led Driver
26 First Socket
27 Second Socket
31 Bent Led Driver Left Sidewall
32 Bent Led Driver Right Sidewall
33 Bent Led Driver Front Sidewall
34 Bent Led Driver Rear Sidewall

### DETAILED DESCRIPTION OF THE PREFERRED EMBODIMENT

As seen in the first figure, a lighting element is formed as a straight tube. The components from the first figure can be repurposed to make the configuration and the second figure. So there are a pair of different modes for construction, reassembly, or assembly.

The tube has a driver connected to a first lamp and also connected to a second lamp. The driver is connected to the first lamp at a first modular interface. The driver is connected to a second lamp at a second modular interface. The driver can be an LED driver. The driver can be fit inside a tube wall such as a transparent tube wall. The lighting tube has a pair of ends. A first end and a second end can both have electrical connectors such as extending metallic prongs that power the lighting element formed as a tube.

The first modular interface opposes the second modular interface. The LED driver has a pair of ends such as a left end and a right end. The LED driver receives the lamps at opposite sides of the LED driver housing. The LED driver housing can have a socket or plug that fits to the lamps. The LED driver is mounted between the first lamp and the second lamp.

As seen in the second figure, a lighting element can then be formed as a bent tube by reorganizing the modular components. The bent tube has a U-shaped bend. The U-shaped structure has parallel lamps including a first lamp that is parallel to the second lamp. The first lamp has a first modular interface and the second lamp has a second modular interface. The first modular interface connects the LED driver to the first lamp and the second modular interface connects the LED driver to the second lamp. The first lamp fits into a first socket and the second lamp fits into a second socket. The first lamp has electrical connectors that connect to a first socket and the second lamp has electrical connectors that connect to a second socket.

The straight first lamp 11 has a first modular interface 14 and the straight second lamp 12 has a second modular interface 15. The modular interfaces can plug into a driver such as the straight LED driver 13 for a straight configuration. The linear or straight configuration fits into a tube wall 16. The tube wall is a glass or plastic cylindrical tube that encapsulates the elements. Additionally, a first electrical connector 17 can be installed to the first lamp 21 and the second electrical connector 18 can be installed to a second lamp 22.

If the user needs to have a bent lamp, the user can repurpose the straight first lamp 11 to reconfigure it into the first lamp 21 by plugging it into a bent first modular interface 23. The user can then repurpose the straight second lamp 12 by reconfiguring it to become the second lamp 22 by plugging it into the bent second modular interface 24. The bent LED driver 25 can have multiple modular interfaces for connection to the lamps. The LED lamps remain linear, but can be reconfigured into a U bend by either replacing the straight LED driver 13 with a bent LED driver 25, or by having multiple modular interfaces to allow replugging at a different 90° angle. In this manner, a factory need only produce one type of straight LED lamp, which can then be finished into a final assembly in two different ways, either by plugging in a linear configuration, or a U bend configuration. The end user can also then recycle the lamp so that the LED lamps can be reused between a pair of different modes, namely the straight configuration mode and a bent mode.

In either case, the first electrical connector 17 connects to the first socket 26, and the second electrical connector 18 connects to the second socket 27. Therefore, the key feature of the present invention is the reconfigurable geometric shape of the device between the first and second mode. The bent LED driver is so named because although it can be rectangular, it can have electrical interfaces that allow a bent configuration. The bent LED driver can have a bent LED driver left sidewall 31, a bent LED driver right sidewall 32, a bent LED driver front sidewall 33, and a bent LED driver rear sidewall 34.

A key feature of the present invention is that the driver is between the pair of lamps which allows a variety of different configurations.

1. An intermediate driver mount comprising:
a driver having a first end and a second end, wherein the first end is opposite the second end;
a first lamp formed as a linear LED lamp;
a second lamp also formed as a linear LED lamp;
a first modular interface formed between the first end and the first lamp, and a second modular interface formed between the second end and the second lamp;
a tube wall covering the first lamp, the driver, and the second lamp, wherein the driver is mounted between the first lamp and the second lamp;
a first electrical connector formed on the first lamp, wherein the first electrical connector is configured to connect to a first socket; and
a second electrical connector formed on the second lamp, wherein the second electrical connector is configured to connect to a second socket.

2. The intermediate driver mount of claim 1, wherein the first lamp is configured to connect to a bent first modular interface on a bent LED driver, and wherein the second lamp is configured to connect to a bent second modular interface on the bent LED driver, wherein the bent LED driver allows a bent configuration in a U-shape.

3. The intermediate driver mount of claim 2, wherein the bent LED driver is rectangular and has the bent first modular interface and the bent second modular interface on the same sidewall.

4. The intermediate driver mount of claim 3, wherein the driver is an LED driver and is rigidly connected to the first lamp and the second lamp.
